(19) United States
(12) Patent Application Publication
(10) Pub. No.: US 2008/0193137 A1
(43) Pub. Date: Aug. 14, 2008

(54) METHOD AND APPARATUS FOR EXTENDING BROADBAND COMMUNICATION SERVICES OVER A WIRELESS LINK WHILE PROTECTING THE NETWORK FROM PERFORMANCE DEGRADATIONS CAUSED BY THE WIRELESS LINK

(75) Inventors: Robert J. Thompson, Horsham, PA (US); Thomas Weiss, Hatfield, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/672,792

(22) Filed: Feb. 8, 2007

(51) Int. Cl. H04B 10/00

(52) U.S. Cl. 398/115

(57) ABSTRACT

A method and apparatus is provided for communicating information from a customer to a broadband access network. The method begins when a wireless access point receives from a subscriber module a wireless RF carrier signal modulated with customer information. The customer information is demodulated and forwarded to a broadband modem in accordance with a first network protocol. The customer information is modulated by the broadband modem onto a communication channel of the broadband access network, thereby preventing wireless noise and/or interference from being directly coupled into the broadband access network.

### FIELD OF THE INVENTION

The present invention relates to a method and apparatus for providing upstream and downstream wireless connectivity between a broadband access network such as Hybrid-Fiber-Coax (HFC) network and networked devices, while largely insulating the broadband network from noise and/or interference arising over the wireless link.

### BACKGROUND OF THE INVENTION

The delivery of data using the community antenna television (CATV) system has become common in residential areas where CATV is commonly available. The data are delivered both downstream and upstream using available channels and/or frequencies. The end user can connect to such systems through a cable modem that is capable of delivering the downstream data to that user, as well as sending upstream data from the user that are intended to reach another node of the system. The cable modem is often compliant with the Data Over Cable Service Interface Specifications (DOCSIS), which is an interface specification for standard, interoperable, data-over-cable network products.

Because providers of CATV systems expect to deliver additional services, such as data for Internet connectivity, there is an interest to serve as many customers as possible. However, it is not always economically feasible to provide a direct connection to each customer location. For example, some customers may be located a significant distance away from the nearest CATV system and would incur substantial installation costs to construct a cable link to it. Accordingly, to deliver data services to areas that are in the proximity of the service provider's service area, but which are not currently reached by a distribution coax cable, wireless links are sometimes employed. For instance, service providers can use the Multipoint Microwave Distribution System (MMDS), which is compatible with DOCSIS. MMDS channels are licensed and therefore require the service provider to purchase or lease a license in order to provide wireless data services. Recently, 300 MHz of bandwidth in the 5 GHz band defined by the Unlicensed National Information Infrastructure (U-NII) spectrum has been set aside to provide such data services. Four bands are defined in this spectrum: 5.15 to 5.25 GHz and 5.25 to 5.35 GHz, which are designated for wireless LAN and other shorter-range use; 5.47 to 5.725 GHz; and 5.725 to 5.825 GHz for wide-area networking that reaches a greater distance with higher power. The U-NII bands are designated for wideband, high-data-rate digital communications. They are also license-free, i.e., no license is required to operate on the U-NII bands.

The use of a wireless receiver operating over a wireless link to access the CATV system, particularly in an unlicensed portion of the spectrum, could cause the injection of upstream noise and/or interference into the CATV system. The injection of an unacceptable level of noise by a wireless receiver happens whenever a user attempts to optimize the wireless link and therefore impairs the signal-to-noise ratio of the upstream CATV channel. Additionally, the CATV channel could be impaired by significant interference from other devices that maybe transmitting within the same frequency range of the wireless link. The noise levels allowed on a CATV system, i.e. a signal-to-noise ratio (SNR), could be on the order of about 30 decibels (dB). The wireless link would require a signal to have a challenging 40 dB SNR or higher to be transparent to the CATV system. In a system requiring the use of many such links, the noise injection in the system would be beyond that allowed by CATV system specifications.

Various solutions have been proposed to reduce the noise levels. For example, in some cases the wireless receivers are switched on and off or, in other words, they are connected and disconnected from the CATV system. In other cases a burst detection system is employed to determine when bursts of data are being received by the wireless receiver. The wireless receiver is then only connected to the CATV system when injecting data upstream, thereby reducing the overall noise injection. These approaches, however, create spectral spreading because high speed switching transients occur, potentially rendering them at least as problematic as the noise levels they are designed to ameliorate.

### SUMMARY OF THE INVENTION

In accordance with the present invention, a method and apparatus is provided for communicating information from a customer to a broadband access network. The method begins when a wireless access point receives from a subscriber module a wireless RF carrier signal modulated with customer information. The customer information is demodulated and forwarded to a broadband modem in accordance with a first network protocol. The customer information is modulated by the broadband modem onto a communication channel of the broadband access network, thereby preventing wireless noise and/or interference from being directly coupled into the broadband access network.

In accordance with one aspect of the invention, the customer information may be modulated onto the communication channel of the broadband access network in accordance with the DOCSIS protocol.

In accordance with another aspect of the invention, the first network protocol may be Ethernet.

In accordance with another aspect of the invention the wireless RF carrier signal may have a bandwidth located in the Unlicensed National Information Infrastructure (U-NII) spectrum.

In accordance with another aspect of the invention, the broadband communication network may be a Hybrid-Fiber Coax (HFC) network.

In accordance with another aspect of the invention, the customer information may be received by a wireless access point from a customer premises.

In accordance with another aspect of the invention, the broadband modem may be powered by the broadband network

In accordance with another aspect of the invention, a method is provided for communicating information from a broadband access network to a customer. The method begins by demodulating data received from a broadband access network. The demodulated data is forwarded in accordance with a first network protocol. The forwarded data is modulated onto a wireless RF carrier signal for transmission to a subscriber module. Network management needed to facilitate receiving and forwarding of the data is provided by a network management system associated with the broadband access network.

In accordance with another aspect of the invention, a wireless access point is provided for communicating customer data between a broadband access network and a plurality of subscriber modules each associated with one or more networked elements. The wireless access point includes a network interface for communicating with the broadband access network via a broadband modem and a downstream channel unit for transforming data received by the network interface into a wireless protocol operating over a wireless link. A transmitter is operatively coupled to the downstream channel unit for transmitting data received therefrom over the wireless link. The wireless access point also includes a receiver for receiving data over the wireless link in accordance with the wireless protocol. An upstream channel unit is operatively coupled to the receiver for transforming data received therefrom into a network protocol employed by the network interface and the broadband modem. A network processing element is provided for facilitating receipt and transmission of the data by a network management system associated with the broadband access network.

A method and apparatus has been described for largely insulating a broadband network from noise and/or interference arising over a wireless link. The system prevents noise and/or interference received from an upstream wireless communication by an access point from being propagating up the communication channel to the HFC plant. The system prevents saturation of the communication channel with ingress noise and hence allows a cable system to provide communication signals to a larger number of access points and effectively extend the reach of the communication system.

### BRIEF DESCRIPTION OF THE DRAWINGS

FIG. 1 shows an illustrative communications network that includes a broadband access network such as a CATV system that provides a wired link to the customer premises.

FIG. 2 shows an illustrative communications network that includes a broadband access network that provides a wireless link to the customer premises.

FIG. 3 shows an illustrative communications network that includes a broadband access network that provides a wireless link to the customer premises in accordance with the present invention.

FIG. 4 shows the broadband modem depicted in FIG. 3 when strand mounted in the vicinity of the wireless access point.

FIG. 5 shows one example of the wireless access point depicted in FIG. 3.

FIG. 6 shows a flowchart of one example of a method for communicating information from a customer to a broadband access network over a wireless link.

FIG. 7 shows a flowchart of one example of a method for communicating information from a broadband access network to a customer over a wireless link.

### DETAILED DESCRIPTION

A method and apparatus is provided for wirelessly communicating customer information (e.g., data, voice, audio, video, multimedia) between a broadband access network (e.g., a CATV network) and customer premises equipment (NETWORKED DEVICES) while largely insulating the broadband network from noise and/or interference arising over the wireless link. As detailed below, this isolation is achieved with the use of a cable modem that is situated between the broadband access network and the wireless transmitter/receiver.

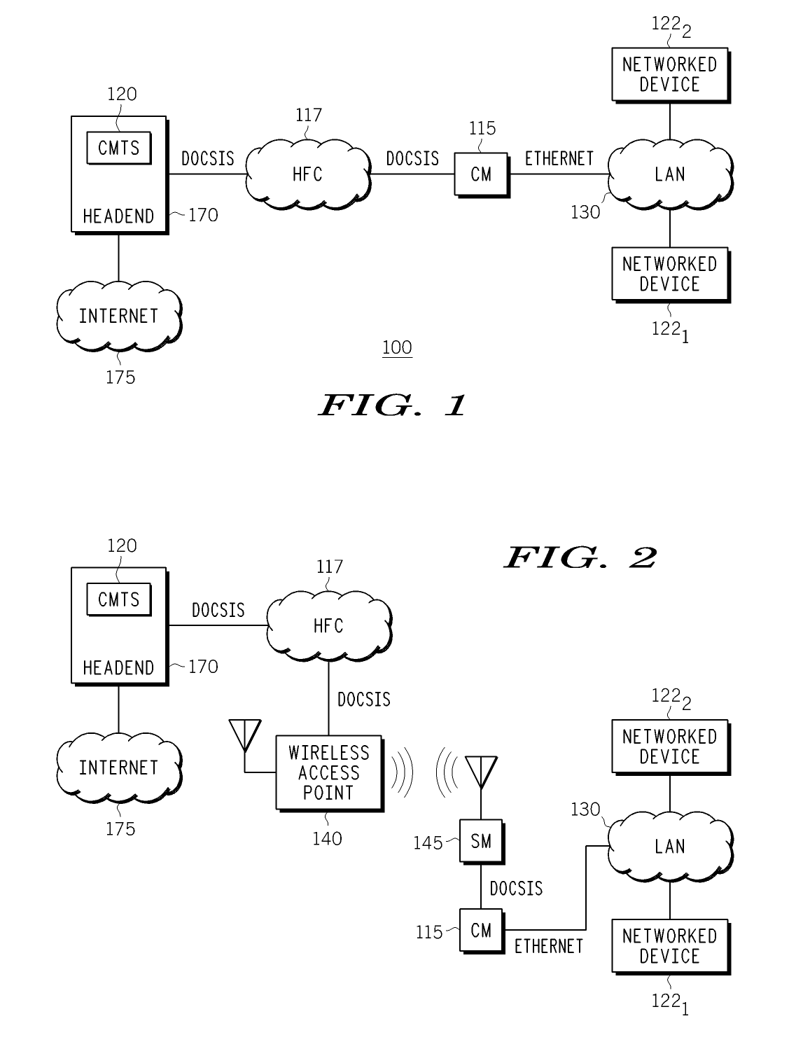

An illustrative communications network 100 that includes a broadband access network such as a CATV system is shown in FIG. 1. Communications network 100 is representative of a network architecture in which subscribers associated with networked devices 122 (e.g., PCs, PDAs, portable computers, media centers, portable media players, mobile telephones and set-top boxes) may access the Internet 175 via a broadband access network 117 such as an HFC network, for example. The Broadband access network 117 and headend 170 are typically provided by an MSO (Multiple System Operator). This broadband access network 117 is also referred to herein as a cable data network. Such cable data networks include multiple network nodes in communication with one another. Broadband access network 117 is typically an all-coaxial or a hybrid-fiber/coax (HFC) network. Of course, other broadband access networks such as xDSL (e.g., ADSL, ADLS2, ADSL2+, VDSL, and VDSL2) may also be employed.

Networked devices 122, and 1222 (collectively networked devices 122) is in communication with the Internet 175 via the HFC network 117, Cable Modem (CM) 115, and CMTS 120, which provide communications services. In other broadband access networks the CM 115 is replaced with a broadband modem suitable for use with the standards and protocols employed by that network. For example, in an xDSL access network, the functionality of the CM 115 would be performed by an xDSL modem. In some cases the CM 115 is integrated with additional components that are sometimes collectively referred to as Customer Premises Equipment (CPE). Headend 170 provides services to a plurality of downstream users (only one of which is shown) and comprises cable modem termination system (CMTS) 120. CM 115 and CMTS 120 modulate data onto communication channels supported by the broadband access network 117 and operate as forwarding agents and also as end-systems (hosts). Their principal function is to transmit Internet Protocol (IP) packets transparently between the headend 170 and the customer location. Data Over Cable Service Interface Specification (DOCSIS) is an international standard developed by CableLabs to provide a series of protocols to implement this functionality. DOCSIS defines the communications and operation support interface requirements for a data over cable system to provide Internet access over HFC networks. Other broadband access networks employ other suitable standards and protocols.

Networked devices 122 (e.g., networked devices 122, and 1222) may be in communication with CM 115 over a Local Area Network (LAN) 130. LAN 130 may employ a packet-based data link or level 3 protocol such as Ethernet, Token Ring, FDDI or the like. Other data link protocols may also be employed. The details of Ethernet, Token Ring and FDDI protocols are well known and are documented in standards, particularly in IEEE Standard 802.3 for Ethernet, IEEE Standard 802.5 for Token Ring and ANSI Standard X3T9.5 for FDDI. LAN 130 may also operate in accordance with a wireless networking protocol that employs any of a variety of different physical and data link communication standards such as a protocol conforming to IEEE 802.11 (also known as “Wi-Fi”) or wireless Ethernet.

The communications system 100 depicted in FIG. 1 requires a wired connection between the broadband access network 117 and the CM 115 located on the customer premises. In many cases it may be desirable to provide broadband wireless access between the broadband network 117 and the customer, which includes LAN 130 and networked devices 122 elements. FIG. 2 shows one example of such a system. In FIGS. 1 and 2, as well as the figures that follow, like elements are denoted by like reference numerals. As shown, a basestation or wireless access point 140 is in communication with broadband access network 117, generally in accordance with DOCSIS in the case of an HFC network. A wireless receiver 145, referred to herein as a Subscriber Module (SM), may be located on the customer premises. A bi-directional wireless RF link is used to establish communication between the wireless access point 140 and SM 145.

In operation, SM 145 demodulates the wireless RF signal received from the wireless access point 140 and transmits the demodulated signals or broadband carriers to the customer's broadband modem 115 in accordance with the appropriate broadband access network protocol (e.g., DOCSIS). The broadband modem 115, in turn, demodulates the received signals, recovering the customer data, which is then forwarded to the LAN 130 in accordance with an appropriate network protocol such as Ethernet. Conversely, upstream data transmitted by the networked devices 122 is received by the broadband modem 115, then modulated onto broadband carriers in accordance with the appropriate broadband access network protocol (e.g. DOCSIS) and transmitted to SM 145, which modulates the data onto a wireless RF carrier and transmits it upstream to the wireless access point 140. The wireless access point 140 demodulates the received wireless RF carrier, recovering the broadband carrier (e.g. DOCSIS) and couples this signal onto the broadband access network 117. The broadband network 117 transmits the data upstream to CMTS 120 on the selected channel.

As previously mentioned, wireless access point 140 can cause the injection of upstream noise and/or interference into broadband network 117, particularly in unlicensed portions of the spectrum such as the U-NII band. Such impairments may be generated by other devices operating in the same portion of the wireless spectrum. Such noise and/or interference could be sufficiently great to corrupt any packets that are being transmitted.

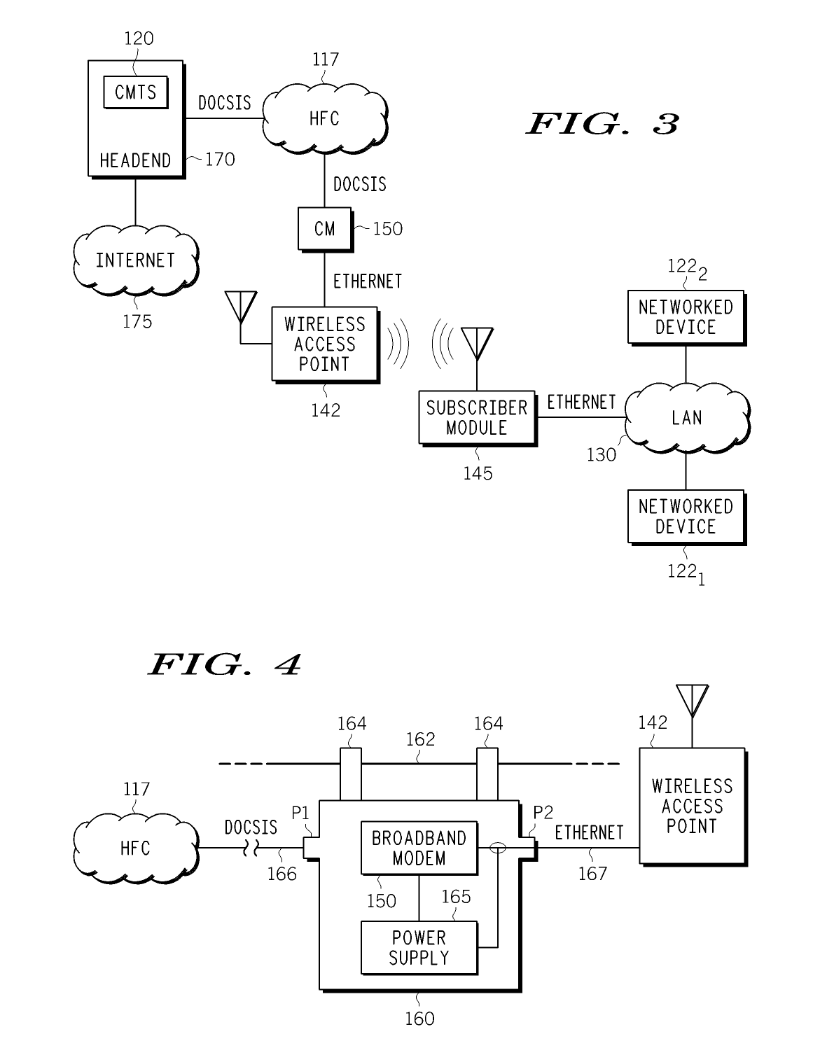

FIG. 3 illustrates an architecture in which a broadband modem 150 is placed between the wireless access point 142 and broadband network 117. Preferably, an upstream communication from networked device 122 is provided to subscriber module 145 through LAN 130. The subscriber module modulates the upstream communication and wirelessly transmits the upstream communication to access point 142. The access point 142 receives wireless communications from subscriber module 145 and packetizes the received wireless communications. The packetized communications are provided to broadband modem 150 at which the packetized information is modulated and transmitted in accordance to the communication protocol for the HFC network, e.g. the DOCSIS protocol.

In this architecture illustrated in FIG. 3, all communications, including the customer information and any noise or interference are preferably packetized. Those of skill in the art will appreciate that the packets containing noise or interference generally do not contain data and will simply be discarded by the network, e.g. by the CMTS 120 as being “null”, “dummy” or “corrupted” packets. Those of skill in the art will appreciate that the architecture of FIG. 3 prevents noise and interference which may result from the wireless communication from affecting the upstream communication channel to the HFC network, i.e. prevents noise and interference received by the wireless access point 142 from being coupled into the upstream path of the broadband network 117. The broadband modem 150 may also be configured to recognize the noise packets as “null”, “dummy” or “corrupted” packets and drop those packets to further reduce communications to the HFC network, and hence reduce communication traffic and loads. If the broadband network 117 is an HFC network, broadband modem 150 is preferably a cable modem.

In one particular example the broadband wireless access link between the Broadband network 117 and the customer premises is established using a wireless network platform such as a broadband wireless Internet platform available from Motorola, Inc. under the tradename Motorola Canopy™. In one implementation the platform employs unlicensed portions of the electromagnetic spectrum over metropolitan distances. In particular, the platform may operate in the Unlicensed National Information Infrastructure (U-NII) spectrum between 5.725-5.825 GHz and the Industrial Scientific and Medical (ISM) spectrum between 902-928 MHz, 2.400-2.500 GHz and 5.725-5.875 GHz.

In operation, upstream data transmitted by the networked devices 122 is received by the SM 145, which modulates the data onto a wireless RF carrier and transmits it upstream to the wireless access point 142. The wireless access point 142 demodulates the received wireless RF carrier and forwards the upstream data to the broadband modem 150 in accordance with an appropriate network protocol such as Ethernet. Broadband modem 150, in turn, modulates the upstream data onto a communication channel supported by the broadband network 117 in accordance with an appropriate protocol such as DOCSIS or the like. The resultant DOCSIS signal is then transmitted to the CMTS 120 over the broadband network 117. In this way any noise and/or interference that may be present when the data is communicated over the wireless RF carrier will not be aggregated onto the broadband network's upstream communication channel.

Broadband modem 150 may be situated at any point between the broadband network 117 and the wireless access point 142, provided of course that the distance between the modem 150 and the wireless access point 142 does not exceed the distance over which data can be transmitted. For example, in the case of Ethernet, the broadband modem 150 and the wireless access point 142 will generally be limited to about 100 meters or less. For example, it will sometimes be convenient to co-locate the broadband modem 150 with the wireless access point 142. Since the wireless access point 142 is generally aerially mounted on a building or tower, the broadband modem 150 may be enclosed in a housing to protect it from physical damage and environmental elements, such as moisture, dirt and the like. The housing may have a strand-mount configuration so that it can be attached to the strand which supports the cable entering the CM 150 from the broadband network 117.

FIG. 4 shows such an arrangement in which the broadband modem 150 is enclosed in housing 160. One or more strand clamps 164 are connected to the housing 160 so that the housing 160 can be attached to the strand 162. In the strand-mount configuration, a first portion of the transmission medium 166 (e.g., copper conductor, optical fiber, coax) can enter housing 160 through a first port P1. A second portion of transmission medium 167 can enter housing 160 through a second port P2. In some cases the housing 160 and broadband modem 150 assembly may be physically hardened in a variety of ways well known to those of ordinary skill to protect it from damage when in an uncontrolled environment so that, for example, it can withstand typical external temperature fluctuations. Power may be supplied to the broadband modem 150 by the pre-existing powering infrastructure that is generally available in the broadband network. In this case a power supply 165 may be provided to convert the broadband network power to an acceptable input power for the electronics associated with both the broadband modem 150 and the wireless access point 142. A directional coupler may be employed to provide both power and RF connectivity to the broadband modem 150.

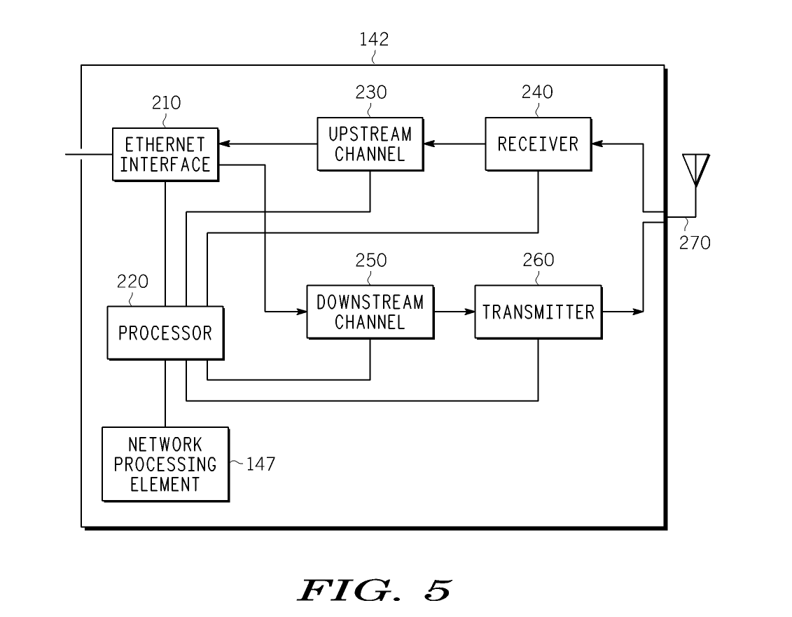

FIG. 5 shows one example of the wireless access point 142 depicted in FIG. 3. wireless access point 142 includes Ethernet or other network interface 210, processor 220, upstream channel unit 230, downstream channel unit 250, wireless receiver 240, wireless transmitter 260 and antenna 270. The operation of the wireless access point 142 is performed under the control of the processor 220. The Ethernet or other network interface 210 is provided for communicating with the cable modem 150. A downstream channel unit 250 extracts Ethernet data provided to Ethernet interface 210 and formats the data so that it is compatible with the wireless protocol employed by the wireless RF link between wireless access point 142 and SM 145. Transmitter 260 receives the formatted data from the downstream channel unit 250 and wirelessly transmits it to the SM 145 via antenna 270. Receiver 240 receives wireless signals from SM 145 and provides the data to upstream channel unit 230, which transforms the data from the protocol employed over the wireless link into an Ethernet-compatible format so that it can be communicated to cable modem 150 via Ethernet interface 210. In some cases the cable modem 150 may be directly incorporated into wireless access point 142. It should be noted that both the wireless access point 142 and the SM 145 include network level processing capabilities (e.g., network processing element 147 in FIG. 5) to facilitate network management under the control of the broad and operator's network management systems. That is, unlike a wireless router, for instance, message management that may be needed to facilitate transmission of customer data by the wireless access point 142 is provided by the network management system associated with the broadband access network 117. For example, both the wireless access point 142 and the SM 145 fully support the Dynamic Host Configuration Protocol (DHCP), enabling them to be automatically configured with IP configurations controlled by the broadband operator via a centralized DHCP server. These capabilities are additional network capabilities which are traditionally not supported by conventional wireless routers and network interface cards. Of course, a wireless access point can also operate over much greater distances than a wireless router so that it can serve multiple customer premises.

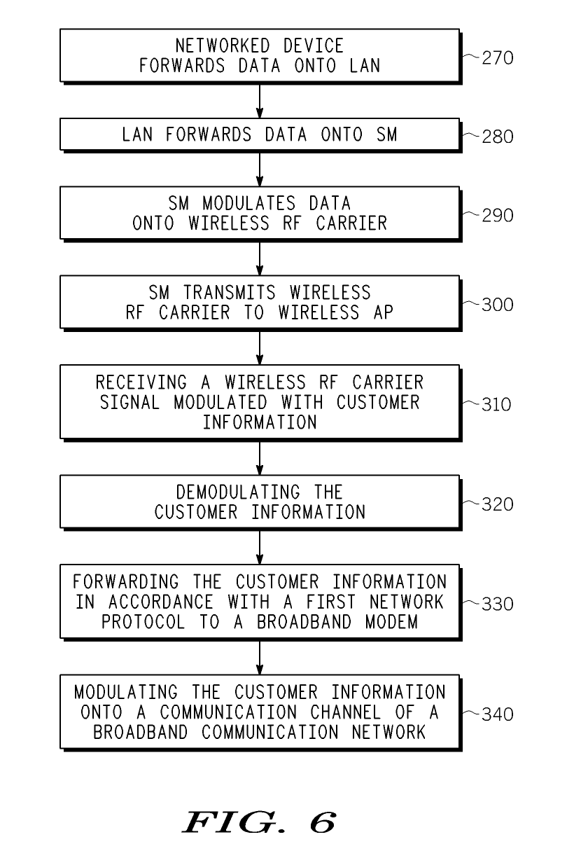

FIG. 6 is a flowchart showing one example of a method for communicating information from a customer to a broadband access network over a wireless link. The method begins in step 270 where the networked devices 122 forwards data onto the LAN 130 and in step 280 the LAN 130 forwards the data onto the subscriber module 145. In step 290, the subscriber module modulates the data onto a wireless RF carrier signal and, in step 300, the subscriber module transmits the wireless RF carrier signal to the wireless access point 142 A wireless RF carrier signal is received in step 310, which is modulated with customer information. The format employed over the wireless link may be any appropriate protocol, either defined in accordance with a standard or a proprietary protocol such as the protocol employed by the Canopy™ Platform, for example. Next, in step 320, the customer information is demodulated and placed into a packetized format. In step 330, the packetized data is forwarded in accordance with a first network protocol such as Ethernet to a broadband modem. Finally, in step 340 the customer information is modulated onto a communication channel of a broadband communication network by the broadband modem.

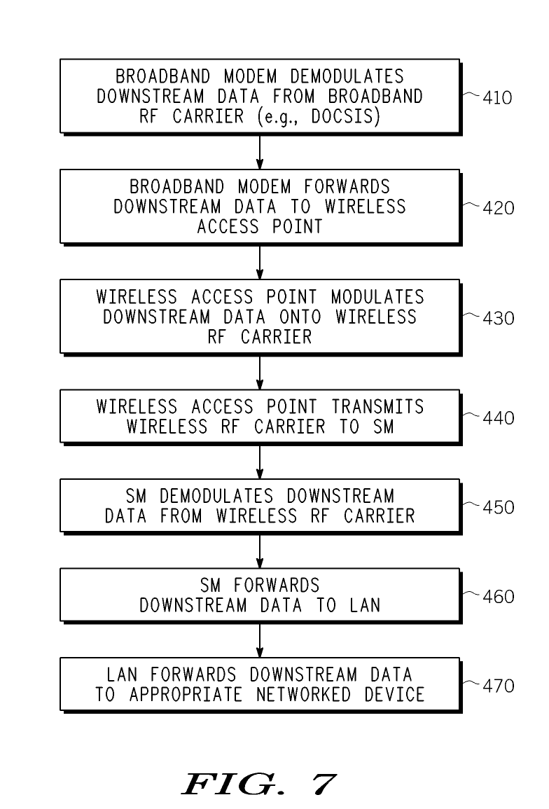

FIG. 7 is a flowchart showing one example of a method for communicating information from a broadband access network to a customer over a wireless link. The method begins in step 410 by demodulating data received from a broadband communication network with a broadband modem. In step 420 the demodulated data is forwarded by the broadband modem to the network interface of the wireless access point in accordance with a first network protocol such as Ethernet. The data received by the wireless access point is modulated onto a wireless RF carrier signal in step 430 for transmission to the appropriate customer premises equipment. The method continues with step 440, where the wireless access point transmits the wireless RF carrier signal to the subscriber module. In step 450, the subscriber module demodulates the wireless RF carrier, recovering the downstream data. In step 460, the downstream data is then forwarded onto the LAN 130. In step 470, the downstream data is then forwarded to the appropriate networked devices 122.

A method and apparatus has been described for largely insulating a broadband network from noise and/or interference arising over a wireless link. The system prevents noise and/or interference received from an upstream wireless communication by an access point from being propagating up the communication channel to the HFC plant. The system prevents saturation of the communication channel with ingress noise and hence allows a cable system to provide communication signals to a larger number of access points and effectively extend the reach of the communication system.

1. A method for communicating information from a customer to a broadband access network, comprising:
receiving customer information from networked elements and modulating this customer information onto a wireless RF carrier signal
transmitting a wireless RF carrier signal modulated with customer information
receiving the wireless RF carrier signal modulated with customer information;
demodulating the wireless RF carrier signal and packetizing the customer information and noise received with the wireless RF signal;
forwarding the packetizing customer information and noise and/or interference in accordance with a first network protocol; and
modulating the packetizing customer information and noise and/or interference onto a communication channel of the broadband access network,
whereby the noise and/or interference is prevented from being directly coupled into the broadband access network.

2. The method of claim 1 wherein the customer information is forwarded to a broadband modem and the modulation of the customer information is performed by the broadband modem.

3. The method of claim 1 wherein the customer information is modulated onto the communication channel of the broadband access network in accordance with the DOCSIS protocol.

4. The method of claim 1 wherein the first network protocol is Ethernet.

5. The method of claim 1 wherein the wireless RF carrier signal has a bandwidth located in the Unlicensed National Information Infrastructure (U-NII) spectrum.

6. The method of claim 1 wherein the broadband communication network is a Hybrid-Fiber Coax (HFC) network.

7. The method of claim 1 wherein the customer information is received by a wireless access point from a customer premises.

8. The method of claim 2 wherein the broadband modem is powered by the broadband network

9. A method for communicating information from a broadband access network to a customer, comprising:
demodulating data received from a broadband access network;
forwarding the demodulated data in accordance with a first network protocol, wherein management needed to facilitate receiving and forwarding of the data is provided by a network management system associated with the broadband access network; and
modulating the forwarded data onto a wireless RF carrier signal for transmission to a subscriber module.

10. The method of claim 9 wherein the data is demodulated by a broadband modem.

11. The method of claim 9 wherein the data is received from the broadband communication network in accordance with a DOCSIS protocol.

12. The method of claim 9 wherein the first network protocol is Ethernet.

13. The method of claim 9 wherein the wireless RF carrier signal has a bandwidth located in the Unlicensed National Information Infrastructure (U-NII) spectrum.

14. The method of claim 9 wherein the broadband communication network is a Hybrid-Fiber Coax (HFC) network.

15. The method of claim 9 wherein the subscriber module demodulates the data from the wireless RF carrier signal and further comprising forwarding the demodulated data to the networked elements.

16. A wireless access point for communicating customer data between a broadband access network and a plurality of subscriber modules each associated with one or more networked devices, comprising:
a network interface for communicating with the broadband access network via a broadband modem;
a downstream channel unit for transforming data received by the network interface into a wireless protocol operating over a wireless link;
a transmitter operatively coupled to the downstream channel unit for transmitting data received therefrom over the wireless link;
a receiver for receiving data over the wireless link in accordance with the wireless protocol;
an upstream channel unit operatively coupled to the receiver for transforming data received therefrom into a network protocol employed by the network interface and the broadband modem and packetizing the data and noise and/or interference in accordance with a the network protocol; and
a network processing element for facilitating receipt and transmission of the data by a network management system associated with the broadband access network.

17. The wireless access point of claim 16 wherein the network protocol employed by the network interface and the broadband modem is Ethernet.

18. The wireless access point of claim 16 wherein the wireless link operates in a bandwidth located in the Unlicensed National Information Infrastructure (U-NII) spectrum.

19. The wireless access point of claim 16 further comprising a broadband modem operatively coupled to communicate with the network interface.

20. The wireless access point of claim method of claim 19 wherein the broadband modem is powered by the broadband access network.

21. A broadband access network, comprising:
a plurality of network nodes in communication with one another over at least one communication channel;
a broadband modem in communication with at least one of the network nodes over the communication channel; and
a wireless access point for communicating data between the broadband modem and a plurality of subscriber modules each associated with one or more networked devices, said wireless access point including:
a network interface for communicating with the broadband modem in accordance with a network protocol;
a downstream channel unit for transforming data received by the network interface into a wireless protocol operating over a wireless link;
a transmitter operatively coupled to the downstream channel unit for transmitting data received therefrom over the wireless link;
a receiver for receiving data over the wireless link in accordance with the wireless protocol;
an upstream channel unit operatively coupled to the receiver for transforming data received therefrom into the network protocol employed by the network interface and the broadband modem and packetizing the data and noise and/or interference in accordance with a the network protocol.

22. The broadband access network of claim 21 wherein the network protocol employed by the network interface and the broadband modem is Ethernet.

23. The broadband access network of claim 21 wherein the communication channel operates in accordance with a DOCSIS protocol.

24. The broadband access network of claim 21 wherein the wireless link operates in a bandwidth located in the Unlicensed National Information Infrastructure (U-NII) spectrum.
